(19) United States
(12) Patent Application Publication
(10) Pub. No.: US 2008/0242182 A1
(43) Pub. Date: Oct. 2, 2008

(54) Method of forming electrode of plasma display panel

(76) Inventors: Chul-Hong Kim, Suwon-si (KR); Hyun-Mi Jeong, Suwon-si (KR); Yeon-Joo Choi, Suwon-si (KR); Min-Hee Lee, Suwon-si (KR)

Correspondence Address: ROBERT E. BUSHNELL, 1522 K STREET NW, SUITE 300, WASHINGTON, DC, 20005-1202, US

(21) Appl. No.: 12/078,335

(22) Filed: Mar. 28, 2008

(30) Foreign Application Priority Data
Mar. 28, 2007 (KR) 10-2007-0030366

(51) Int. Cl. H01J 9/12

(52) U.S. Cl. 445/49

(57) ABSTRACT

A method of forming electrodes of a plasma display panel comprises forming a first metal layer on a substrate, forming a second metal layer on the first metal layer using an offset printing method, forming first electrodes by baking the second metal layer, and forming second electrodes by etching the first metal layer using the first electrodes as masks.

### CLAIM OF PRIORITY

This application makes reference to, incorporates the same herein, and claims all benefits accruing under 35 U.S.C. §119 from an application earlier filed in the Korean Intellectual Property Office on the 28 Mar. 2007 and there duly assigned Serial No. 10-2007-0030366.

### BACKGROUND OF THE INVENTION

1. Technical Field

The present invention relates to a method of forming electrodes of a plasma display panel and, more particularly, to a method of forming electrodes having a multi-layer structure.

2. Related Art

Plasma display panels (PDPs) have attracted public attention because they are replacing conventional cathode-ray tube (CRT) display devices. A plasma display panel displays images by exciting phosphors having a predetermined pattern using ultraviolet rays generated in a discharge gas sealed between two substrates comprising a plurality of electrodes when a discharge voltage is applied to the plurality of electrodes.

In general, optical transmitting electrodes and bus electrodes are disposed on a front substrate of the PDP. A bus electrode complements the electric conductivity of an optical transmitting electrode and is formed of a double layer comprising a black layer and a white layer.

A black paste is printed and baked, and a white paste is printed, baked, and then patterned in order to form the bus electrode having a double layer structure comprising the black layer and the white layer. The patterning process uses a photo mask to conduct exposure and developing processes, which increases the manufacturing costs and reduces the process yield.

To address this problem, an embossing type offset printing method of forming electrodes has been suggested. Japanese Patent Laid-Open Publication No. 2004-18589 discloses a method of forming bus electrodes by forming a black layer using an offset printing method and forming a white layer on the black layer using an offset printing method. However, transparent electrodes, black layers, and white layers are not properly aligned, and thus a distribution of characteristics such as a proportion of a black color and external reflection/brightness occurs, which considerably reduces reliability of the PDP.

### SUMMARY OF THE INVENTION

The present invention provides a method of forming electrodes of a plasma display panel in which electrodes are effectively aligned, thereby increasing reliability of the plasma display panel and reducing the number of processes to be performed, and thereby increasing the ability to produce the plasma display panel.

The present invention also provides a method of forming electrodes of a plasma display panel in which reliability and productibility of the plasma display panel are increased.

According to an aspect of the present invention, a method of forming electrodes of a plasma display panel comprises: forming a first metal layer on a substrate; forming a second metal layer on the first metal layer using an offset printing method; forming first electrodes by baking the second metal layer; and forming second electrodes by etching the first metal layer using the first electrodes as masks.

The method may further comprise: forming an etching mask on the first electrodes; etching the first metal layer using the etching mask and the first electrodes as masks; and forming the second electrodes by removing the etching mask.

The forming of the etching mask may comprise: forming a light reduction layer on the first electrodes; and etching the light reduction layer using photo and exposure processes, and forming the etching mask which exposes a part of the first metal layer where the first electrodes are not formed.

The forming of the etching mask may comprise: forming a light reduction layer on the first electrodes; and etching the light reduction layer using photo and exposure processes, and forming the etching mask which exposes a part of the first metal layer.

The etching mask may used to etch the first metal layer so that second electrodes and a panel light absorption layer are formed.

The second metal layer may be baked using ultraviolet (UV) curing.

The first metal layer may be wet etched compared with the first electrodes using a developing solution having an excellent etching selection ratio.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1 thru 6 are cross-sectional views illustrating a method of forming electrodes of a plasma display panel according to an embodiment of the present invention;

FIGS. 7 and 8 are cross-sectional views illustrating electrodes which are not baked, and which are respectively baked using UV curing according to an embodiment of the present invention; and

FIG. 9 is a partially cut-away perspective view illustrating a plasma display panel comprising bus electrodes formed using a method of forming electrodes according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein. In the drawings, irrelevant descriptions are omitted in order to clearly describe the present invention.

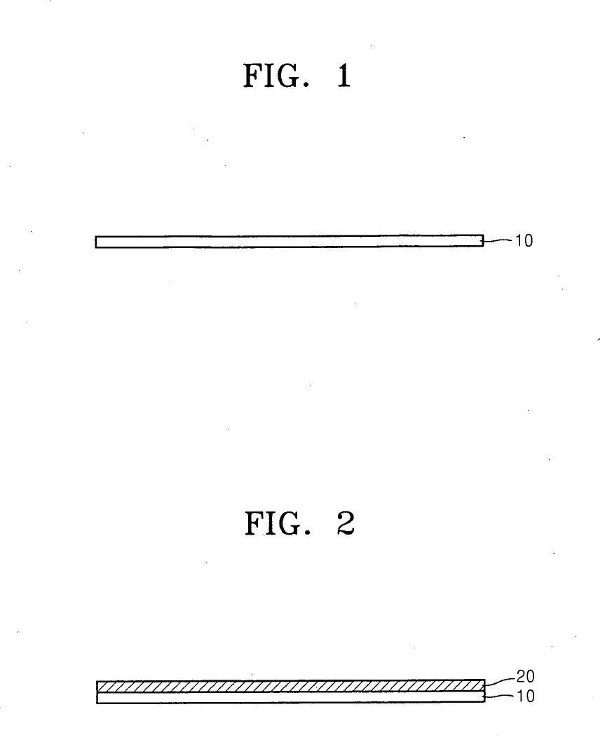

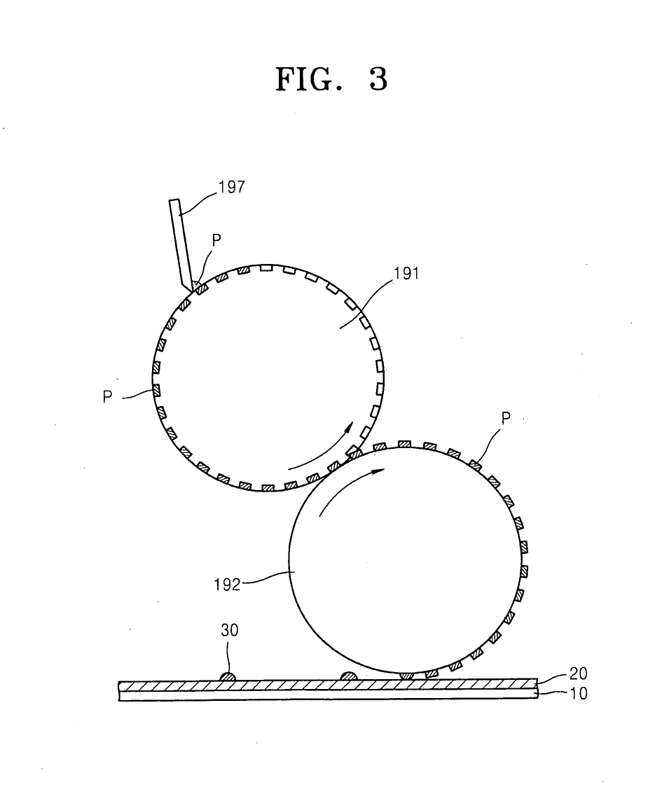

FIGS. 1 thru 6 are cross-sectional views illustrating a method of forming electrodes of a plasma display panel according to an embodiment of the present invention.

Referring to FIG. 1, a substrate 10 is prepared. The method of forming electrodes of the plasma display panel of the present embodiment can be used to form bus electrodes of the plasma display panel. Therefore, the single-layer substrate 10 is described in the present embodiment. However, since a plasma display panel generally has bus electrodes formed on transparent electrodes, a substrate in which transparent electrodes are disposed can be prepared.

Referring to FIG. 2, a first metal layer 20 is formed on the substrate 10. In more detail, the substrate 10 can be coated with a first paste formed of a conductive material, a frit component, a binder, a solvent, or the like using a screen printer. The first metal layer 20 can be further prepared on the substrate 10 by baking the first paste using heat or light and evaporating the solvent. UV curing can be used to bake the first paste in order to prevent the first paste from being damaged by heat. The first metal layer 20 can also be formed on the whole surface of the substrate 10 using deposition and printing methods, as well as using the method of coating and baking the first paste to form the first metal layer 20. When electrodes are formed on the plasma display panel according to the present embodiment, the first metal layer 20 can be formed of a conductive material having low luminosity, i.e., a black type color, in order to increase the proportion of the black color and improve contrast. For example, a black conductive material is copper (Cu).

Referring to FIG. 3, a second metal layer 30 is formed on the first metal layer 20 which is formed on the substrate 10 using an offset printing method. In more detail, the first metal layer 20 which is formed on the substrate 10 is disposed under a gravure roll 191 and a blanket roll 192 which rotates in the opposite direction relative to the gravure roll 191, and which engages with the gravure roll 191. The gravure roll 191 includes grooves which are filled with a second paste P. The second paste P which overflows from the grooves is removed using a blade 197.

The second paste P can be formed of a conductive material, a frit component, a binder, a solvent, or the like, similarly to the first paste. When electrodes are formed on the plasma display panel according to the present embodiment, the second paste P can be formed of an excellent electric conductive material, i.e., silver (Ag), thereby forming white electrodes having high luminosity.

The gravure roll 191 and the blanket roll 192 rotate so that the second paste P which is filled in the grooves of the gravure roll 191 is transferred to the surface of the blanket roll 192. The substrate 10, on which the first metal layer 20 is formed, is transported so that the second paste P transferred to the surface of the blanket roll 192 is printed on predetermined parts of the first metal layer 20. Therefore, the second metal layer 30 is formed on the first metal layer 20.

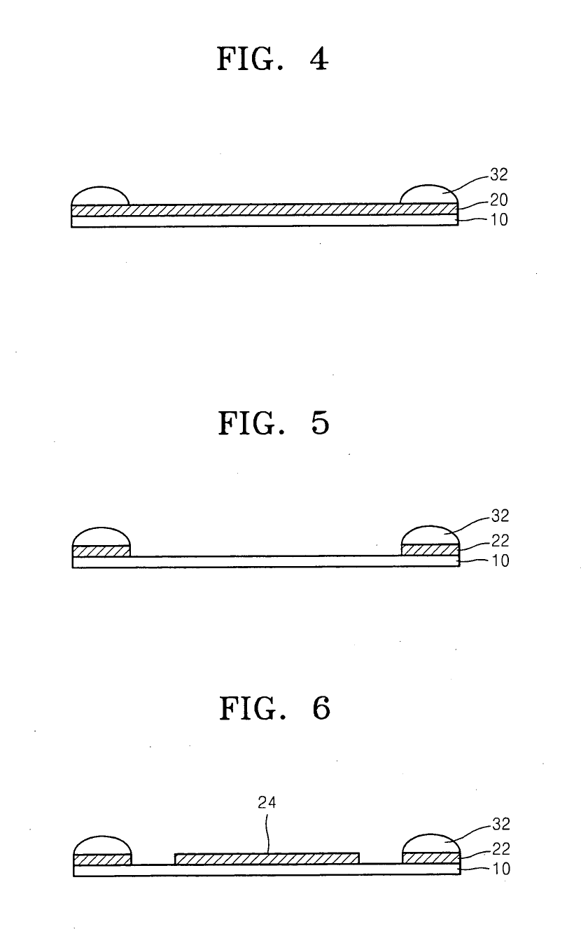

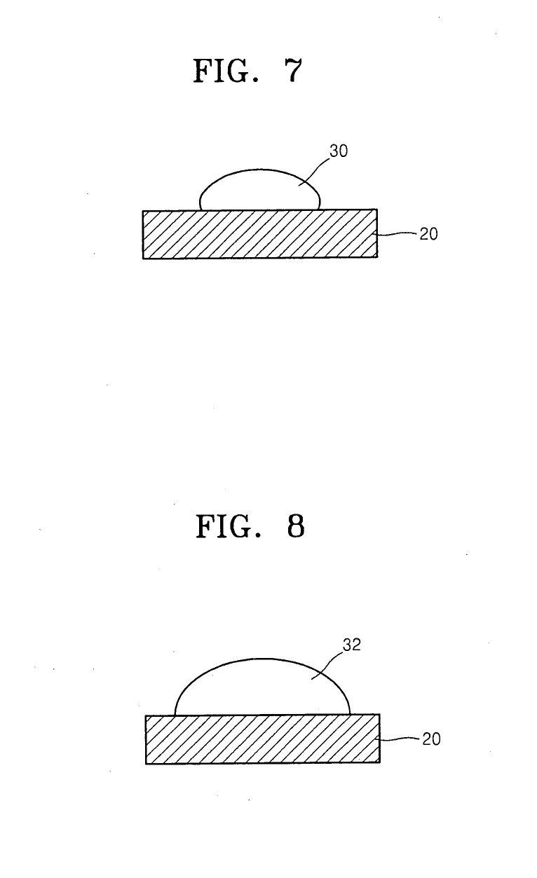

Referring to FIG. 4, a product obtained by forming the first metal layer 20 and the second metal layer 30 on the substrate 10 is baked so that the solvent is removed from the second metal layer 30 to form first electrodes 32. The first electrodes 32 are formed of a white conductive material, and thus they can have high luminosity. UV curing is used to bake the first electrodes 32, which prevents the first electrodes 32 from being transformed by heat. In the present embodiment, the first electrodes 32 are substantially hardened during baking so that the first electrodes 32 can be used as a mask in a subsequent etching process. The baking of the first electrodes 32 prevents the first electrodes 32 from becoming spherical so that the resistance of the first electrodes 32 can be reduced. This will be described with reference to FIGS. 7 and 8.

Referring to FIG. 5, the first metal layer 20 is etched by using the first electrodes 32 formed of the white material as an etching mask. At this time, a portion of the first metal layer 20 which is not exposed by the first electrodes 32 is not etched, but another portion thereof which is exposed by the first electrodes 32 is etched so that second electrodes 22 can be formed and self-aligned. The second electrodes 22 are formed of a black conductive material, and thus they have low luminosity. Since a photo mask for forming an electrode is not used to form the first electrodes 32 and the second electrodes 22, the first electrodes 32 and the second electrodes 22 can naturally align. When the method of forming electrodes according to the present embodiment is used to form electrodes having more than two layers, a photo mask is not used to form electrodes, and electrodes are self-aligned, so that electrodes are not erroneously aligned, and the number of processes to be performed is reduced.

The first metal layer 20 can be wet etched compared with the first electrodes 32 using a developing solution having an excellent etching selection ratio. The first electrodes 32 and the first metal layer 20 include an acid binder so that an alkali solution can be used as a developing solution used to etch the first metal layer 20 which is exposed by the etching mask by separating the bonds of the acid binder. For example, the developing solution can include ammonia (NH₃), sodium carbonate (Na₂CO₃), or the like.

In the present embodiment, the first metal layer 20 is a metal layer which is not patterned, and the second electrodes 22 are formed by patterning the first metal layer 20. The second metal layer 30 is a metal layer which is not baked, and the first electrodes 32 are formed by baking the second metal layer 30.

Referring to FIG. 6, a panel light absorption layer 24 is disposed on the substrate 10. A light reduction layer is formed on the product illustrated in FIG. 4 in order to form the panel light absorption layer 24. The light reduction layer is etched using photo and exposure processes, and is patterned so that a part of the first metal layer 20 and the first electrodes 32 for the panel light absorption layer 24 are not exposed. Subsequently, the patterned light reduction layer and the first electrodes 32 are used as an etching mask in order to etch the first metal layer 20, so that the second electrodes 22 and the panel light absorption layer 24 can be simultaneously formed. Thus, the white type colored first electrodes 32, the black type colored second electrodes 22, and the panel light absorption layer 24 can be formed on desired parts of the substrate 10. Accordingly, the photo process for forming the first electrodes 22 is not required, thereby reducing the number of processes to be performed.

FIGS. 7 and 8 are cross-sectional views illustrating electrodes which are not baked and which are respectively baked using UV curing according to an embodiment of the present invention.

Referring to FIG. 7, corners of the second metal layer 30 formed on the first metal layer 20 are edge-curled due to a difference between shrinkage of the second paste. However, the second metal layer 30 can be baked using UV curing, thereby preventing the second metal layer 30 from being damaged by heat. Referring to FIG. 8, the corners of the second metal layer 30 are less edge-curled than those shown in FIG. 7, and thus the characteristics of a withstand voltage are increased. Therefore, the resistance of the first electrodes 32 can be reduced.

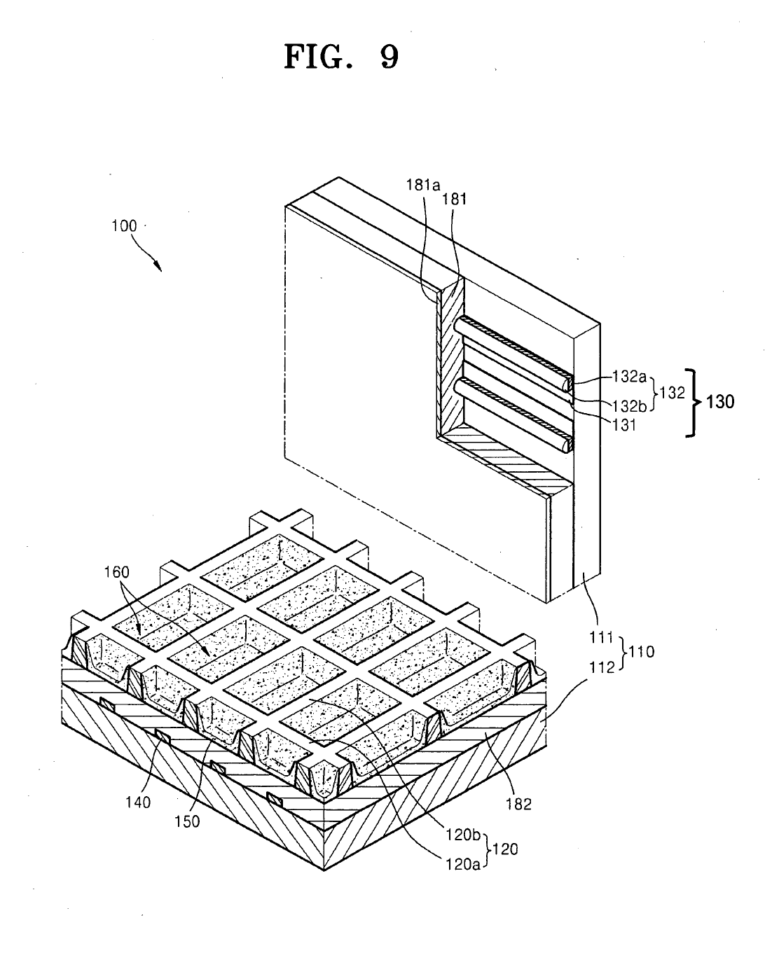

FIG. 9 is a partially cut-away perspective view illustrating a plasma display panel comprising bus electrodes formed using a method of forming electrodes according to an embodiment of the present invention.

Referring to FIG. 9, the plasma display panel 100 comprises a pair of substrates 110, barrier ribs 120, sustain electrodes 130, address electrodes 140, and phosphor layers 150.

The pair of substrates 110 includes a first substrate 111 and a second substrate 112, and the first substrate 111 and the second substrate 112 are spaced apart from each other by a predetermined distance and face each other. The first substrate 111 is formed of transparent glass which can transmit visible light.

In the present embodiment, since the first substrate 111 is transparent, visible light generated by a discharge is transmitted through the first substrate 111, but the present invention is not limited thereto. As an alternative, both the first substrate 111 and the second substrate 112 can be formed of a transparent material. Also, the first substrate 111 and the second substrate 112 can be formed of a semi-transparent material and include a color filter on the surface or inside thereof.

The barrier ribs 120 are disposed between the pair of substrates 110. The barrier ribs 120 maintain a discharge distance and partition discharge spaces with the sustain electrodes 130 to form discharge cells 160, and prevent electric and optical cross-talk between the partitioned discharge cells 160.

The barrier ribs 120 comprise horizontal barrier ribs 120a which are disposed parallel to the sustain electrodes 130, and vertical barrier ribs 120b which are disposed perpendicular to the horizontal barrier ribs 120a.

In the present embodiment, the discharge cells 160 have rectangular cross-sections which are partitioned by the barrier ribs 120, but the present invention is not limited thereto. The discharge cells 160 can have polygonal cross-sections such as triangular cross-sections, pentagonal cross-sections, circular cross-sections, oval cross-sections, or the like. The barrier ribs 120 can be disposed in a stripe shape so that the barrier ribs 120 form open cell structures.

Meanwhile, the sustain electrodes 130 comprise light transmitting electrodes 131 and bus electrodes 132.

The light transmitting electrodes 131 are disposed in a stripe shape on a lower surface of the first substrate 111, and are formed of indium tin oxide (ITO) through which visible light is transmitted. The ITO has a thickness of about 0.10-0.15 μm.

According to the present embodiment of the invention, the light transmitting electrodes 131 are formed of ITO, but the present invention is not limited thereto. That is, the light transmitting electrodes 131 can be formed of a material which has excellent electric conductivity, and which can transmit visible light, and thus may be a material other than ITO having those characteristics.

According to the present embodiment of the invention, the light transmitting electrodes 131 are formed on the first substrate 111, but the present invention is not limited thereto. That is, the plasma display panel 100 of the present invention may not include light transmitting electrodes 131. In this case, the bus electrodes 132 are divided into several pieces in order to reduce the width thereof, so that an open ratio can be increased and simultaneously a sustain discharge can be generated.

Meanwhile, the bus electrodes 132 are disposed to reinforce electric conductivity of the light transmitting electrodes 131 and are double-layered. That is, the bus electrodes 132 include first bus electrode layers 132a and second bus electrode layers 132b.

The first bus electrode layers 132a having a thickness of about 1.3-1.7 μm are disposed on the light transmitting electrodes 131. The second bus electrode layers 132b having a thickness of about 5-5.5 μm are disposed on the first bus electrode layers 132a.

The first bus electrode layers 132a are formed of copper (Cu), and thus have a low luminosity. Therefore, the first bus electrode layers 132a have a black type color, thereby efficiently absorbing visible light.

In the present embodiment, the term “black type color” refers not only to black, but also to any colors that can efficiently absorb visible light, for example, dark gray, brown, and the like.

The second bus electrode layers 132b are formed of silver (Ag), and thus have a high luminosity. The second bus electrode layers 132b have a white type color, and have excellent electric conductivity. The second bus electrode layers 132b are formed using an offset printing method, and thus have a spherical surface.

According to the present embodiment, the second bus electrode layers 132b are formed and etched to form an etching mask, and the first bus electrode layers 132a are formed so that the bus electrodes 132 having the double layer structure can be efficiently aligned.

A first dielectric layer 181 is disposed on the first substrate 111, and buries the light transmitting electrodes 131, the bus electrodes 132, and the panel light absorption layer 170.

The first dielectric layer 181 prevents direct conduction between the sustain electrodes 130 during the sustain discharge, and prevents charged particles from directly colliding with the sustain electrodes 130 and damaging the sustain electrodes 130, and first dielectric layer 181 accumulates wall charge by inducing charged particles. The dielectric substance of dielectric layer 181 is PbO, B₂O₃, SiO₂, or the like.

A protection layer 181a is disposed on a lower surface of the first dielectric layer 181. The protection layer 181a is formed of magnesium oxide (MgO). The protection layer 181a prevents the sustain electrodes 130 from being damaged by sputtered plasma particles, and emits second electrons to reduce the discharge voltage.

Meanwhile, the address electrodes 140 are disposed in a stripe shape on the second substrate 112. The address electrodes 140 perform address discharge with those electrodes, among the sustain electrodes 130 formed on the first substrate 111, that serve as scanning electrodes.

A second dielectric layer 182 is formed on the second substrate 112 so as to bury the address electrodes 140. The second dielectric layer 182 protects the address electrodes 140.

Meanwhile, a top surface of the second dielectric layer 182, which forms the lower surface of the discharge cells 160, and sides of the barrier ribs 120 are coated with phosphors emitting blue, green and red visible light from phosphor layers 150.

The phosphor layers 150 are divided into blue light emitting phosphor layers, green light emitting phosphor layers, and red light emitting phosphor layers according to colors of emitted visible light, each being disposed in rows.

Each phosphor layer 150 receives ultraviolet rays and emits visible light. The blue light emitting phosphor layers are coated with a phosphor such as BaMgAl₁₀O₁₇:Eu, the green light emitting phosphor layers are coated with a phosphor such as Zn₂SiO₄:Mn, and the red light emitting phosphor layers are coated with a phosphor such as Y(V,P)O₄:Eu.

After the first substrate 111 and the second substrate 112 are sealed together, the inner spaces of the plasma display panel 100 contain air. The air is completely exhausted from the plasma display panel 100, and is replaced with an appropriate discharge gas which increases discharge efficiency. The discharge gas, in general, is a mixture gas such as Ne—Xe, He—Xe, He—Ne—Xe, etc.

The present invention provides a method of forming electrodes of a plasma display panel having a multilayer structure in which electrodes self-align. Therefore, electrodes are efficiently aligned, and thus reliability of the plasma display panel is increased. Photo and exposure processes which use a photo mask for forming electrodes are not performed, so that the number of processes required for forming electrodes is reduced, and thus the ability to produce the plasma display panel can be increased.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of forming electrodes of a plasma display panel, comprising the steps of:
forming a first metal layer on a substrate;
forming a second metal layer on the first metal layer using an offset printing method;
forming first electrodes by baking the second metal layer; and
forming second electrodes by etching the first metal layer using the first electrodes as masks.

2. The method of claim 1, further comprising the steps of:
forming an etching mask on the first electrodes;
etching the first metal layer using the etching mask and the first electrodes as masks; and
forming the second electrodes by removing the etching mask.

3. The method of claim 2, wherein the step of forming the etching mask comprises:
forming a light reduction layer on the first electrodes; and
etching the light reduction layer using photo and exposure processes, and forming the etching mask which exposes a part of the first metal layer where the first electrodes are not formed.

4. The method of claim 2, wherein the step of forming the etching mask comprises:
forming a light reduction layer on the first electrodes; and
etching the light reduction layer using photo and exposure processes, and forming the etching mask which exposes a part of the first metal layer.

5. The method of claim 4, wherein the etching mask is used to etch the first metal layer so that the second electrodes and a panel light absorption layer are formed.

6. The method of claim 5, wherein the first metal layer is wet etched compared with the first electrodes using a developing solution having an excellent etching selection ratio.

7. The method of claim 2, wherein the first metal layer is wet etched compared with the first electrodes using a developing solution having an excellent etching selection ratio.

8. The method of claim 1, wherein the second metal layer is baked using ultraviolet (UV) curing.

9. The method of claim 1, wherein the first metal layer is wet etched compared with the first electrodes using a developing solution having an excellent etching selection ratio.
